(19) United States
(12) Patent Application Publication
(10) Pub. No.: US 2010/0045915 A1
(43) Pub. Date: Feb. 25, 2010

(54) LIQUID CRYSTAL DISPLAY

(75) Inventors: Sang-Yong NO, Seoul (KR); Young-Je CHO, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/478,288

(22) Filed: Jun. 4, 2009

(30) Foreign Application Priority Data
Aug. 25, 2008 (KR) 10-2008-0082979

(51) Int. Cl. G02F 1/1333; G02F 1/1343

(52) U.S. Cl. 349/138; 349/141

(57) ABSTRACT

A liquid crystal display according to an exemplary embodiment of the present invention includes a first insulating substrate, a first subpixel electrode on the first insulating substrate, an organic insulator on the first subpixel electrode and having a first contact hole, and a second subpixel electrode on the organic insulator, and connected to the first subpixel electrode through the first contact hole. Accordingly, one thin film transistor is disposed in each pixel thereby improving the aperture ratio of the liquid crystal display, and the same data signal is applied to the first and second subpixel electrodes through one thin film transistor such that side visibility may be increased through a simple driving method.

This application claims priority to Korean Patent Application No. 10-2008-0082979, filed on Aug. 25, 2008, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display. More particularly, the present invention relates to a liquid crystal display having two subpixel electrodes and a method of improving a driving method of the liquid crystal display.

(b) Description of the Related Art

A liquid crystal display is one of the most widely used flat panel displays, and it is composed of two display panels on which field generating electrodes are formed, and a liquid crystal layer interposed between the two display panels. A voltage is applied to the field generating electrodes to generate an electric field on the liquid crystal layer, and the orientation of liquid crystal molecules of the liquid crystal layer is determined and the polarization of incident light is controlled through the generated electric field to display an image.

Among the liquid crystal displays, a vertical alignment mode liquid crystal display, which aligns liquid crystal molecules such that the long axes of the liquid crystal molecules are perpendicular to the panels in the absence of an electric field, is spotlighted because of its high contrast ratio and wide reference viewing angle. A reference viewing angle is defined as a viewing angle that makes the contrast ratio equal to 1:10 or as a limit angle for inversion in luminance between the grays.

In the vertical alignment mode liquid crystal display, a wide viewing angle can be realized by cutouts such as minute slits in the field-generating electrodes and protrusions on the field-generating electrodes. Since the cutouts and protrusions can determine the tilt directions of the liquid crystal molecules, the tilt directions can be distributed by using the cutouts and protrusions such that the reference viewing angle is widened.

On the other hand, the vertical alignment mode liquid crystal display has lower side visibility compared with front visibility, such that one pixel is divided into two subpixels and a high voltage and a low voltage are applied to the two subpixels to solve this problem. Accordingly, the arrangement directions of the liquid crystal molecules corresponding to two subpixel electrodes are different, thereby improving the visibility of the right and left viewing angle directions.

### BRIEF SUMMARY OF THE INVENTION

It has been determined herein that the conventional method in which the pixel electrode is divided into two subpixel electrodes that are applied with different voltages to increase the visibility has a complicated structure, and the manufacturing cost is high, the driving method is complicated, and/or the transmittance of the liquid crystal display is decreased.

Accordingly, in the present invention, the structure of the liquid crystal display is simplified to reduce the manufacturing cost, a wide viewing angle and a fast response speed are obtained through a simple driving method, and visibility and transmittance are improved.

An liquid crystal display according to an exemplary embodiment of the present invention includes a first insulating substrate, a first subpixel electrode disposed on the first insulating substrate, an organic insulator disposed on the first subpixel electrode and having a first contact hole, and a second subpixel electrode disposed on the organic insulator, and connected to the first subpixel electrode through the first contact hole.

A thickness of the organic insulator may be in a range of about 1 μm to about 2 μm, and may be about 1.5 μm.

The first subpixel electrode and the second subpixel electrode may be disposed in one pixel, and an area ratio between the first subpixel electrode and the second subpixel electrode may be in a range of about 1:1 to about 2:1.

The organic insulator may be a color filter.

A surface of the organic insulator may have substantially a same height as a surface of the second subpixel electrode.

The liquid crystal display may further include a second insulating substrate facing the first insulating substrate, a common electrode formed on the second insulation substrate, and a liquid crystal layer interposed between the first insulating substrate and the second insulating substrate.

An electric field generated between the first subpixel electrode and the common electrode may be weaker than an electric field generated between the second subpixel electrode and the common electrode.

A thickness of the liquid crystal layer between the first subpixel electrode and the common electrode may be substantially same as a thickness of the liquid crystal layer between the second subpixel electrode and the common electrode.

The liquid crystal display may further include a gate line and a data line disposed under the organic insulator, and a thin film transistor connected to the gate line and the data line, wherein the organic insulator has a second contact hole exposing the drain electrode of the thin film transistor, and the second subpixel electrode is connected to the drain electrode through the second contact hole.

If a data voltage is applied to the second subpixel electrode through the drain electrode, and a common voltage is applied to the common electrode, then an electric field generated between the first subpixel electrode and the common electrode may be weaker than an electric field generated between the second subpixel electrode and the common electrode.

An assistance member disposed under the first subpixel electrode corresponding to the first contact hole and disposed in a same layer as the gate line may be further included.

An electric field generated between the first subpixel electrode and the common electrode may be weaker than an electric field generated between the second subpixel electrode and the common electrode.

The liquid crystal layer may include a plurality of liquid crystal molecules, and when a voltage is not applied between the first subpixel electrode and the second subpixel electrode, and the common electrode, the long axis of the liquid crystal molecules may be perpendicular to the surface of the first and second insulating substrates.

The second subpixel electrode may include a plurality of minute branches having four subregions with different length directions of the minute branches.

The liquid crystal molecules may be pretilted in the length directions of the minute branches.

The second subpixel electrode may include a transverse stem and a longitudinal stem forming a boundary of four subregions.

The second subpixel electrode may enclose the first subpixel electrode in a plan view.

When the first subpixel electrode and the data line are projected on a same plane, projection patterns may be separated from each other.

The data line may include a first portion disposed on a first imaginary straight line, a second portion disposed on a second imaginary straight line separated from the first imaginary straight line and parallel to the first imaginary straight line, and a third portion connecting the first portion and the second portion to each other, and the second subpixel electrode overlaps the first portion of the data line.

The common electrode may include at least one cutout.

According to an exemplary embodiment of the present invention, one pixel is divided into two subpixel electrodes that are connected to one thin film transistor, and the intensity of the electric field formed between the two subpixel electrodes and the common electrode is controlled to be different thereby improving the visibility. Accordingly, the structure of the liquid crystal display is not complicated, and a liquid crystal display having excellent visibility and transmittance may be provided while having a wide viewing angle and a fast response speed through a simple driving method.

### BRIEF DESCRIPTION OF THE DRAWINGS

The above and other features and advantages of the present invention will become more apparent by describing exemplary embodiments thereof with reference to the accompanying drawings, in which:

FIG. 1 is a block diagram of an exemplary liquid crystal display according to an exemplary embodiment of the present invention;

FIG. 2 an equivalent circuit diagram of two exemplary subpixels in an exemplary liquid crystal display according to an exemplary embodiment of the present invention;

FIG. 3 is an equivalent circuit diagram of one exemplary pixel in an exemplary liquid crystal display according to an exemplary embodiment of the present invention;

FIG. 4 is a layout view of one exemplary pixel in an exemplary liquid crystal display according to an exemplary embodiment of the present invention;

FIG. 5 is a cross-sectional view of the exemplary liquid crystal display shown in FIG. 4 taken along line V-V;

FIG. 6 is a cross-sectional view of an exemplary liquid crystal display of another exemplary embodiment of the present invention;

FIG. 7 is a cross-sectional view of an exemplary liquid crystal display of another exemplary embodiment of the present invention;

FIG. 8 is a layout view of an exemplary liquid crystal display of another exemplary embodiment of the present invention;

FIG. 9 is a cross-sectional view of the exemplary liquid crystal display shown in FIG. 8 taken along line IX-IX;

FIG. 10 is a cross-sectional view of an exemplary liquid crystal display of another exemplary embodiment of the present invention;

FIG. 11 is a cross-sectional view of an exemplary liquid crystal display of another exemplary embodiment of the present invention;

FIGS. 12A and 12B are graphs of a gamma curve line showing transmittance per gray according to an experimental example; and

FIG. 13 is an index of visibility of the experimental example.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

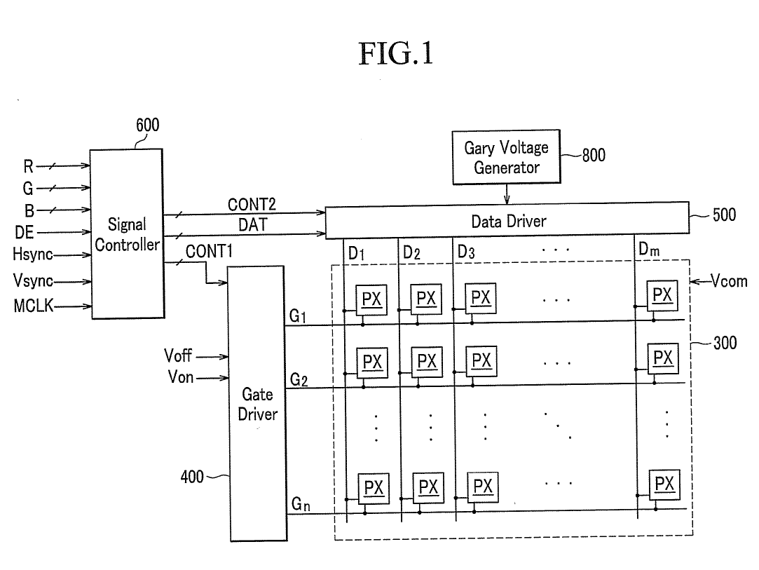

Firstly, a liquid crystal display according to an exemplary embodiment of the present invention will be described with reference to FIG. 1 to FIG. 3 in detail.

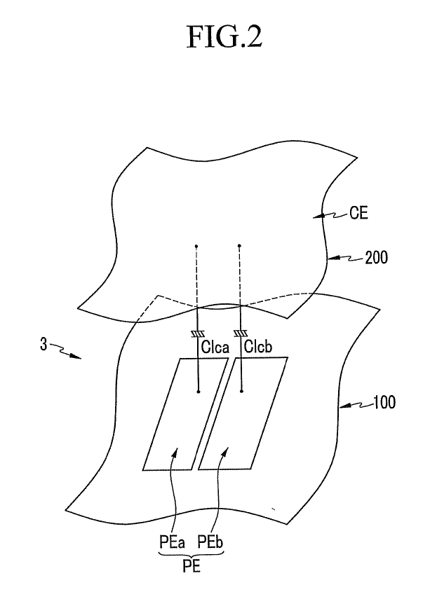

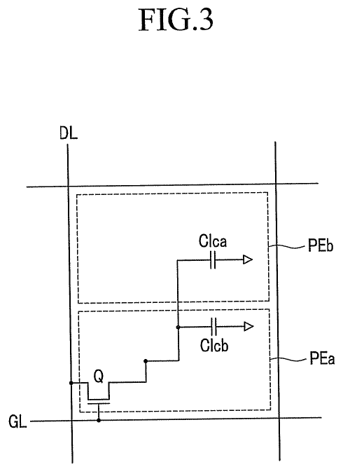

FIG. 1 is a block diagram of an exemplary liquid crystal display according to an exemplary embodiment of the present invention, FIG. 2 an equivalent circuit diagram of two exemplary subpixels in an exemplary liquid crystal display according to an exemplary embodiment of the present invention, and FIG. 3 is an equivalent circuit diagram of one exemplary pixel in an exemplary liquid crystal display according to an exemplary embodiment of the present invention.

As shown in FIG. 1, an exemplary liquid crystal display according to an exemplary embodiment of the present invention includes a liquid crystal panel assembly 300, a gate driver 400 and a data driver 500 connected thereto, a gray voltage generator 800 connected to the data driver 500, and a signal controller 600 for controlling them.

As viewed in an equivalent circuit, the liquid crystal panel assembly 300 includes a plurality of signal lines G1-Gn and D1-Dm, and a plurality of pixels PX that are connected to the plurality of signal lines and disposed in a matrix form. Meanwhile, in a structure shown in FIG. 2, the liquid crystal panel assembly 300 includes lower and upper panels 100 and 200 that face each other, and a liquid crystal layer 3 that is interposed between the panels 100 and 200. As will be further described below, the lower and upper panels 100 and 200 may also be referred to as the thin film transistor array panel 100 and the common electrode panel 200.

The signal lines G1-Gn and D1-Dm include a plurality of gate lines G1-Gn that transmit gate signals (also referred to as “scanning signals”), and a plurality of data lines D1-Dm that transmit data signals. The gate lines G1-Gn substantially extend in a row direction, a first direction, to be parallel to each other, and the data lines D1-Dm substantially extend in a column direction, a second direction, to be parallel to each other. The first direction may be substantially perpendicular to the second direction.

Each pixel PX includes a pair of subpixel electrodes PEa and PEb. The subpixel electrodes PEa and PEb include a switching element Q shown in FIG. 3 connected to the signal lines GL and DL, and a liquid crystal capacitor Clca and Clcb and a storage capacitor (not shown) connected thereto. In an exemplary embodiment, the storage capacitor may be omitted, if necessary.

The switching element Q is a three terminal element such as a thin film transistor provided to the lower panel 100, a control terminal thereof is connected to the gate line GL, an input terminal thereof is connected to the data line DL, and an output terminal thereof is connected to the liquid crystal capacitors Clca/Clcb.

The liquid crystal capacitors Clca/Clcb have two terminals of subpixel electrodes PEa/PEb of the lower panel 100 and a common electrode CE of the upper panel 200, and the liquid crystal layer 3 between the two subpixel electrodes PEa/PEb and CE serves as a dielectric material. The pair of subpixel electrodes PEa and PEb are separated from each other and form one pixel electrode PE, and are electrically connected to each other through a contact hole, as described later in detail. The common electrode CE is formed or otherwise provided on the whole surface, or substantially the entire surface, of the upper panel 200 and receives the common voltage Vcom. The liquid crystal layer 3 has negative dielectric anisotropy. The liquid crystal molecules of the liquid crystal layer 3 may be arranged such that a longitudinal axis of the liquid crystal molecules is perpendicular to the surfaces of the two panels 100, 200 in the case that an electric field does not exist.

It has been determined that a predetermined difference is generated between the voltages charged to two liquid crystal capacitors Clca and Clcb. For example, the data voltage applied to the liquid crystal capacitor Clca is less or more than the data voltage applied to the liquid crystal capacitor Clcb. This will be described in detail below. Therefore, when the voltages of the first and second liquid crystal capacitors Clca and Clcb are appropriately adjusted, it is possible to make an image viewed from the side be as similar as possible to an image viewed from the front, and as a result, it is possible to improve the side visibility.

The storage capacitor functions as an auxiliary capacitor for the liquid crystal capacitor Clc. The storage capacitor includes a pixel electrode PE and a separate signal line (not shown), which is provided on the lower panel 100 and overlaps with the pixel electrode PE via an insulator, and the separate signal line is applied with a predetermined voltage such as a common voltage Vcom. Alternatively, the storage capacitor may include the pixel electrode PE and a previous gate line, which overlaps the pixel electrode PE via an insulator.

For color display, each pixel PX uniquely represents one of three colors (i.e., spatial division), such as primary colors, or each pixel PX sequentially represents the three colors in turn (i.e., temporal division), such that a spatial or temporal sum of the colors is recognized as a desired color. An example of a set of the three colors includes red, green, and blue colors. Although not shown, the color filter may be disposed on or under the subpixel electrodes PEa and PEb of the lower panel 100, or may be disposed under the common electrode CE of the upper panel 200.

At least one polarizer (not shown) is attached on the outer side of the liquid crystal panel assembly 300, and the polarization axis of two polarizers may be crossed. In a reflective liquid crystal display, one of two polarizers may be omitted. In the case of the crossed polarizers, the light incident to the liquid crystal layer 3 is blocked in the absence of the application of the electric field.

Referring again to FIG. 1, the gray voltage generator 800 generates a plurality of gray voltages (or reference gray voltages) related to transmittance of the pixels PX. The (reference) gray voltages may include one set having a positive value for a common voltage Vcom, and another set having a negative value.

The gate driver 400 is connected to the gate lines G1 to Gn of the liquid crystal panel assembly 300, and applies gate signals Vg obtained by combining a gate-on voltage Von and a gate-off voltage Voff to the gate lines G1 to Gn.

The data driver 500 is connected to the data lines D1 to Dm of the liquid crystal panel assembly 300, and selects the gray voltages from the gray voltage generator 800 to apply them to the data lines D1 to Dm as data voltages. However, when the gray voltage generator 800 does not supply a voltage for all grays but supplies only a predetermined number of reference gray voltages, the data driver 500 divides the reference gray voltages to generate the data voltages for the entire grays and selects the data signals among them.

The signal controller 600 controls the gate driver 400 and the data driver 500.

Each of the drivers 400, 500, 600, and 800 may be installed directly on the liquid crystal panel assembly 300 in the form of at least one integrated circuit (“IC”) chip. Alternatively, each of the drivers 400, 500, 600, and 800 may be installed on a flexible printed circuit (“FPC”) film (not shown) to be attached to the liquid crystal panel assembly 300 in the form of a tape carrier package (“TCP”) or installed on a separate printed circuit board (“PCB” not shown).

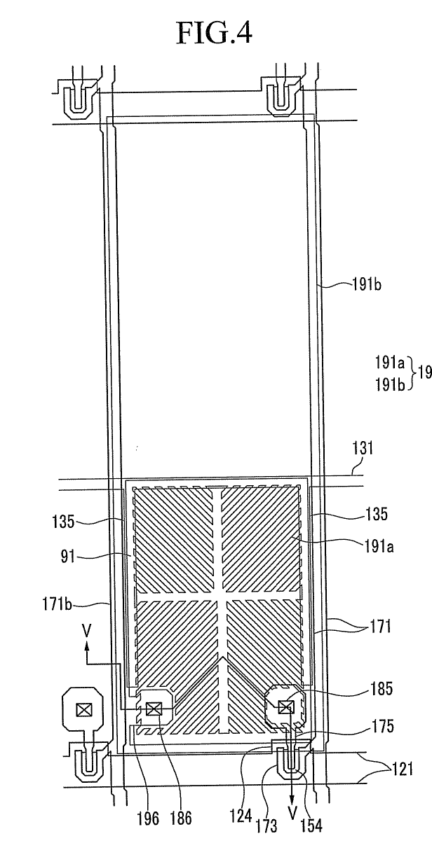

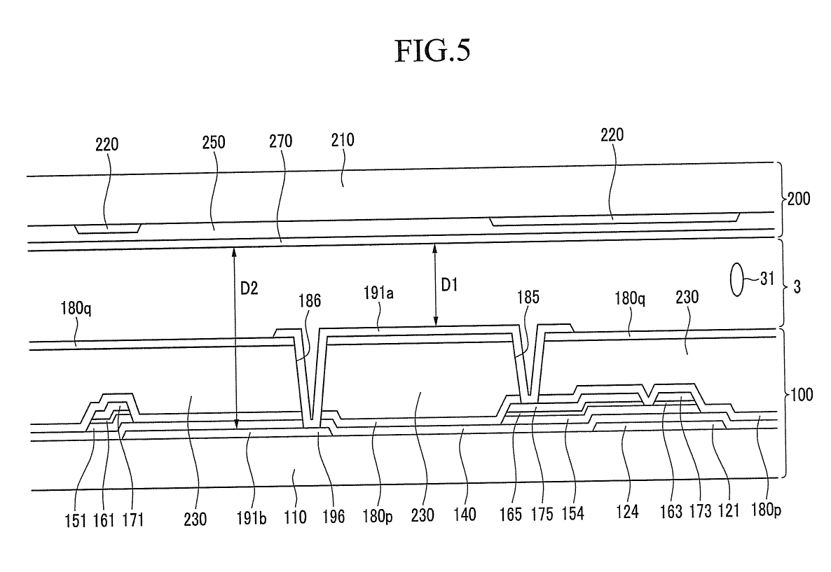

Next, the structure of the liquid crystal panel assembly 300 will be described in detail with reference to FIG. 4 and FIG. 5. FIG. 4 is a layout view of one exemplary pixel of an exemplary liquid crystal display according to an exemplary embodiment of the present invention, and FIG. 5 is a cross-sectional view of the exemplary liquid crystal display shown in FIG. 4 taken along line V-V.

Referring to FIG. 4 and FIG. 5, the liquid crystal display according to the present exemplary embodiment includes a thin film transistor array panel 100 and a common electrode panel 200 that face each other, and a liquid crystal layer 3 interposed therebetween.

Firstly, the thin film transistor array panel 100 will be described.

A plurality of second subpixel electrodes 191b, a plurality of gate lines 121, and a plurality of storage electrode lines 131 are formed or otherwise disposed on an insulation substrate 110. The insulation substrate 110 may be made of transparent glass or plastic.

The overall shape of the second subpixel electrode 191b may be a quadrangle, and includes a protrusion 196 extending along the opposite edges, such as the right and left edges, of a first subpixel electrode 191a. The protrusion 196 of the second subpixel electrode 191b is connected to the first subpixel electrode 191a through a second contact hole 186 that will be described later.

The gate lines 121 transmit gate signals and extend in a transverse direction, such as the first direction, and each gate line 121 includes a plurality of gate electrodes 124 protruding upward from the gate lines 121 towards their respective pixels.

The storage electrode lines 131 extend substantially parallel to the gate lines 121, and a plurality of storage electrodes 135 extend parallel to the data lines 171. The storage electrodes 135 may depend from the storage electrode lines 131.

The shape and arrangement of the storage electrode lines 131 and the storage electrodes 135 may be variously changed.

A gate insulating layer 140 is formed on the gate lines 121 and the storage electrode lines 131 and may be further disposed on exposed portions of the insulation substrate 110.

A plurality of semiconductor stripes 151 preferably made of hydrogenated amorphous silicon (“a-Si”) are disposed on the gate insulating layer 140. The semiconductor stripes 151 extend in the longitudinal direction, the second direction that extends substantially perpendicular to the first direction, and include a plurality of projections 154 extending toward the gate electrodes 124.

A plurality of ohmic contact stripes and islands 161 and 165 are formed or otherwise disposed on the semiconductor stripes 151. The ohmic contacts 161 and 165 may be made of silicide or n+ hydrogenated a-Si in which an n-type impurity such as phosphorus is highly doped. The ohmic contact stripes 161 include a plurality of protrusions 163, and the protrusions 163 and the ohmic contact islands 165 are disposed as a pair on the projections 154 of the semiconductor stripes 151.

A plurality of data lines 171 and a plurality of drain electrodes 175 are provided on the ohmic contacts 161 and 165.

The data lines 171 extend substantially in a longitudinal direction, the second direction, thereby intersecting the gate lines 121. Each of the data lines 171 also intersects the storage electrode lines 131. Each of data lines 171 includes a plurality of source electrodes 173 extending toward the gate electrodes 124. The source electrodes 173 may overlap the protrusions 163 of the ohmic contact stripes 161. The drain electrodes 175 are separated from the data lines 171 and are opposite to the source electrodes 173 with respect to the gate electrodes 124. The drain electrodes 175 may overlap the ohmic contact islands 165. Each drain electrode 175 includes one end portion having a wide area and the other end portion having a bar shape, and the bar end portion may be enclosed by a curved portion of the source electrode 173.

A gate electrode 124, a source electrode 173, and a drain electrode 175 form a thin film transistor along a projection 154 of the semiconductor stripe 151, and the channel of the thin film transistor is formed in the projection 154 of the semiconductor stripe 151 between the source electrode 173 and the drain electrode 175.

The ohmic contacts 161 and 165 are interposed only between the underlying semiconductor stripes 151 and the overlying data lines 171 and the drain electrodes 175 thereon, and reduce contact resistance therebetween. The semiconductor stripes 151 may have substantially the same planar shape as the data lines 171, the drain electrodes 175, and the ohmic contacts 161 and 165. The semiconductor stripes 151 have portions that are exposed without being covered by the data lines 171 and the drain electrodes 175, as well as portions between the source electrodes 173 and drain electrodes 175.

A lower passivation layer 180p preferably made of silicon nitride or silicon oxide is disposed on the data lines 171, the drain electrodes 175, and the exposed semiconductor stripes 151. The lower passivation layer 180p may be further disposed on the exposed portions of the gate insulating layer 140.

A plurality of color filters 230 may be provided on the lower passivation layer 180p. Here, the lower passivation layer 180p prevents the pigments of the color filters 230 from flowing into the exposed semiconductor stripes 151. Each of color filters 230 may display one color in a set of colors such as three colors of red, green, and blue.

The color filters 230 of the liquid crystal display according to an exemplary embodiment of the present invention may have a thickness of about 1 μm to about 2 μm, and more preferably about 1.7 μm to about 1.9 μm. It is preferable that the thickness may be about 1.5 μm. The color filters 230 may be made of a photosensitive organic material.

An upper passivation layer 180q is disposed on the color filters 230. The upper passivation layer 180q may be made of an inorganic material. The upper passivation layer 180q prevents lifting of the color filters 230, and suppresses contamination of the liquid crystal layer 3 by the organic material such that flowing of the solvent from the color filters 230 that causes deterioration such as afterimages generated upon driving the screen may be prevented.

A plurality of the first subpixel electrodes 191a are formed or otherwise disposed on the upper passivation layer 180q.

In a plan view, referring to FIG. 4, the first subpixel electrodes 191a and the second subpixel electrodes 191b are separated via a gap 91 interposed therebetween.

The overall shape of the first subpixel electrodes 191a may also be a quadrangle, and includes a cross-shaped stem having a transverse stem and a longitudinal stem that are crossed. Also, each pixel electrode 191 may be divided into four sub-regions by a transverse stem and a longitudinal stem, and each of the sub-regions may include a plurality of first to fourth minute branches.

The minute branches of one of the four sub-regions obliquely extend from the transverse stem or the longitudinal stem in the upper-left direction, towards a first corner of the pixel, and the minute branches of another of the four sub-regions obliquely extend from the transverse stem or the longitudinal stem in the upper-right direction, towards a second corner of the pixel adjacent to the first corner. Further, the minute branches of another of the four sub-regions obliquely extend from the transverse stem or the longitudinal stem in the lower-left direction, towards a third corner of the pixel adjacent to the first corner and opposite to the second corner, and the minute branches of still another of the four sub-regions obliquely extend from the transverse stem or the longitudinal stem in the lower-right direction, adjacent to the second and third corners and opposite to the first corner of the pixel.

Each of the minute branches forms an angle of about 45 degrees or about 135 degrees with the gate lines 121 or the transverse stem. Also, the minute branches of two neighboring sub-regions may be crossed.

Although not shown, the widths of the minute branches may become wider close to the transverse stem or the longitudinal stem.

The area occupied by the second subpixel electrode 191b may be larger than the area occupied by the first subpixel electrode 191a in the whole pixel electrode 191, and here, the area of the second subpixel electrode 191b may be larger than about 1.0 to about 2.0 times the area of the first subpixel electrode 191a. However, the shape and the area ratio of the first and second subpixel electrodes 191a and 191b may be variously changed.

Each first subpixel electrode 191a is physically and electrically connected to a drain electrode 175 through a first contact hole 185 which is provided through the upper passivation layer 180q, the color filters 230, and the lower passivation layer 180p, and the first subpixel electrode 191a receives data voltages from the drain electrode 175.

Also, each first subpixel electrode 191a is physically and electrically connected to the protrusion 196 of the second subpixel electrode 191b through the second contact hole 186 which passes through the upper passivation layer 180q, the color filters 230, the lower passivation layer 180p, and the gate insulating layer 140, and thus the second subpixel electrode also receives data voltages from the drain electrode 175 via the first subpixel electrode 191a.

Next, the common electrode panel 200 will be described.

A light blocking member 220 is disposed on an insulating substrate 210. The insulating substrate 210 may be made of transparent glass or plastic. The light blocking member 220 is referred to as a black matrix and prevents light leakage.

The light blocking member 220 has a plurality of openings (not shown) facing the pixel electrodes 191 and having substantially the same shape thereof, and prevents the light leakage between them. The light blocking member 220 may include portions corresponding to the gate lines 121 and the data lines 171 and the thin film transistors.

An overcoat 250 is disposed on the light blocking member 220. The overcoat 250 may be made of an organic insulator, and provides a flat surface. In an alternative exemplary embodiment, the overcoat 250 may be omitted.

A common electrode 270 is formed or otherwise disposed on the overcoat 250. The common electrode 270 may be made of a transparent conductor such as indium tin oxide (“ITO”) or indium zinc oxide (“IZO”).

Alignment layers (not shown) may be provided on the inner surface of the display panels 100 and 200 facing the liquid crystal layer 3, and may be vertical alignment layers. Polarizers (not shown) are disposed on the outer surface of the display panels 100 and 200, the polarization axis of two polarizers are crossed, and one polarization axis thereof may be parallel to the gate line 121. In the case of a reflective liquid crystal display, one of two polarizers may be omitted.

The liquid crystal display according to the present exemplary embodiment may further include a retardation film (not shown) to compensate the retardation of the liquid crystal layer 3. The liquid crystal display may include a backlight unit (not shown) for providing light to the polarizers, the phase retardation film, the display panels 100 and 200, and the liquid crystal layer 3.

The liquid crystal layer 3 has negative dielectric anisotropy, and may be oriented such that the major axes of the liquid crystal molecules 31 of the liquid crystal layer 3, which has the pretilt parallel to the length direction of the minute branches of the first subpixel electrodes 191a, are almost perpendicular to the surfaces of the two display panels 100 and 200 when no electric field is applied. Accordingly, incident light is blocked by the crossed polarizers in a state where no electric field is applied.

In the liquid crystal display according to an exemplary embodiment of the present invention, the liquid crystal layer 3 has an almost uniform thickness in each pixel PX.

If the common electrode 270 is applied with the common voltage Vcom and the pixel electrode 191 is applied with the data voltage, an electric field substantially perpendicular to the surface of the display panels 100 and 200 is formed. Thus, liquid crystal molecules 31 of the liquid crystal layer 3 change directions so that the major axes thereof become perpendicular to the direction of the electric field in response to the electric field. The change degree of the polarization of the light that is incident to the liquid crystal layer 3 is changed according to the inclination degree of the liquid crystal molecules 31, and this change of the polarization appears as a change of the transmittance by the polarizer, thereby displaying images on the liquid crystal display.

Here, the edges of the minute branches of the first subpixel electrode 191a distort the electric field to make the horizontal components perpendicular to the edges of the minute branches, and the inclination direction of the liquid crystal molecules 31 is determined to be the direction determined by the horizontal components. However, in the present exemplary embodiment, the liquid crystal molecules 31 are already pretilted in the direction parallel to the length direction of the minute branches such that the liquid crystal molecules 31 are tilted in the pretilted direction. Therefore, if the liquid crystal molecules 31 are provided to have the pretilt, they are tilted in the required direction such that the response speed of the liquid crystal display may be improved.

Also, in an exemplary embodiment of the present invention, the length directions in which the minute branches are extended in one pixel PX are four directions such that the inclined directions of the liquid crystal molecules 31 are all four directions. Therefore, the viewing angle of the liquid crystal display is widened by varying the inclined directions of the liquid crystal molecules 31.

Next, again referring to FIG. 5, the voltage difference per regions of the liquid crystal display according to an exemplary embodiment of the present invention will be described.

Referring to FIG. 5, as above-described, the liquid crystal display includes the first subpixel electrode 191a disposed on the lower passivation layer 180p, the color filters 230, and the upper passivation layer 180q, and the second subpixel electrode 191b disposed under the lower passivation layer 180p, the color filters 230, and the upper passivation layer 180q. Accordingly, while the first subpixel electrode 191a and the second subpixel electrode 191b are applied with the same data voltage, the interval D1 between the first subpixel electrode 191a and the common electrode 270 and the interval D2 between the second subpixel electrode 191b and the common electrode 270 are different from each other, thus the intensities of the electric field within the region occupied by the first subpixel electrode 191a and within the region occupied by the second subpixel electrode 191b are different, thereby improving the side visibility.

In the region occupied by the first subpixel electrode 191a, the field generating electrodes 191a and 270 overlap each other via the liquid crystal layer 3 such that the electric field created by the voltage difference of the field generating electrodes 191a and 270 is generated to the liquid crystal layer 3, however, in the region occupied by the second subpixel electrode 191b, the field generating electrodes 191b and 270 overlap each other via the lower passivation layer 180p, the color filters 230, and the upper passivation layer 180q as well as the liquid crystal layer 3 such that the electric field between the two electrodes 191b and 270 is formed on the liquid crystal layer 3 and is dispersed on the lower passivation layer 180p, the color filters 230, and the upper passivation layer 180q.

Accordingly, the first subpixel electrode 191a and the second subpixel electrode 191b are connected to each other through the second contact hole 186 such that the same data voltage is applied thereby forming the same voltage difference with the common electrode 270, however the electric field applied to the liquid crystal layer 3 in the region occupied by the first subpixel electrode 191a is stronger than the electric field applied to the liquid crystal layer 3 in the region occupied by the second subpixel electrode 191b.

The inclination angle of the liquid crystal molecule 31 is changed according to the intensity of the electric field such that the intensity of the electric field applied to the liquid crystal layer 3 of the region occupied by the first subpixel electrode 191a and the region occupied by the second subpixel electrode 191b and the inclined angle of the liquid crystal molecules 31 are different, and as a result, the luminance of the two regions are different. Accordingly, if the intensity of the electric field applied to the liquid crystal layer 3 in the region occupied by the first subpixel electrode 191a and the intensity of the electric field applied to the liquid crystal layer 3 in the region occupied by the second subpixel electrode 191b are appropriately controlled, the side gamma curve may be approximate to the front gamma curve, thereby improving the side visibility.

In the liquid crystal display according to the present exemplary embodiment, although the first subpixel electrode 191a and the second subpixel electrode 191b are respectively on and under the passivation layer 180p and 180q, and the color filters 230, and are connected to each other through the contact hole 186 such that one thin film transistor is formed in one pixel and the same data signal is applied to the first and second subpixel electrodes 191a and 191b, it may be controlled that the electric field applied to the liquid crystal layer 3 within the region occupied by the first subpixel electrode 191a is stronger than the electric field applied to the liquid crystal layer 3 within the region occupied by the second subpixel electrode 191b. Accordingly, one thin film transistor is disposed in each pixel, thereby improving the aperture ratio of the liquid crystal display, and the same data signal is applied to the first and second subpixel electrodes 191a and 191b through one thin film transistor such that the side visibility may be increased through a simple driving method.

Also, as above-described, in the liquid crystal display according to an exemplary embodiment of the present invention, the liquid crystal layer 3 has an almost uniform thickness in the regions occupied by both the first subpixel electrode 191a and the second subpixel electrode 191b. Accordingly, the deterioration of the display quality that is generated due to the thickness of the liquid crystal layer 3 may be prevented.

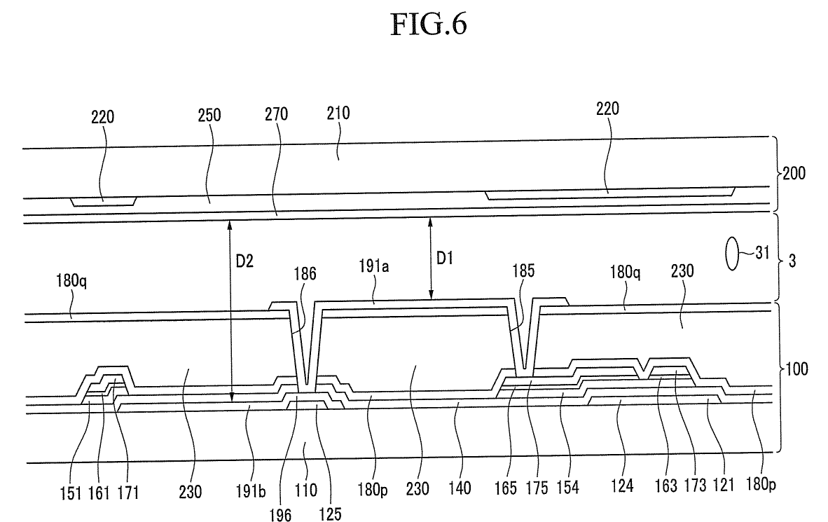

Next, an exemplary liquid crystal display according to another exemplary embodiment of the present invention will be described with reference to FIG. 6, and with further reference to FIG. 4. FIG. 6 is a cross-sectional view of an exemplary liquid crystal display according to another exemplary embodiment of the present invention.

The structure of the liquid crystal display shown in FIG. 6 according to the present exemplary embodiment is similar to that of the liquid crystal display of FIG. 4 and FIG. 5.

However, different from the thin film transistor array panel 100 shown in FIG. 4 and FIG. 5, an assistance member 125 is disposed within the same layer as the gate line 121 on the insulation substrate 110 under the protrusion 196 of the second subpixel electrode 191b. The protrusion 196 is connected to the first subpixel electrode 191a through the second contact hole 186. Also, the second subpixel electrode 191b is connected to the first subpixel electrode 191a through the second contact hole 186 disposed on the assistance member 125.

The assistance member 125 may reduce the depth of the second contact hole 186 which passes through the gate insulating layer 140, the lower passivation layer 180p, the color filter 230, and the upper passivation layer 180q such that the contact of the first subpixel electrode 191a and the second subpixel electrode 191b is complemented.

Many characteristics of the liquid crystal display shown in FIG. 4 and FIG. 5 may be applied to the liquid crystal display shown in FIG. 6.

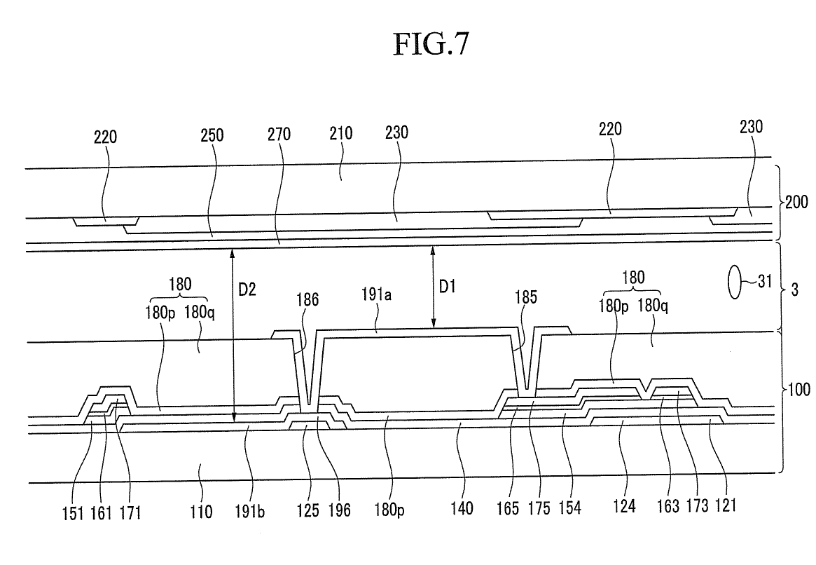

Next, an exemplary liquid crystal display according to another exemplary embodiment of the present invention will be described with reference to FIG. 7, and with further reference to FIG. 4. FIG. 7 is a cross-sectional view of an exemplary liquid crystal display according to another exemplary embodiment of the present invention.

The structure of the liquid crystal display according to the present exemplary embodiment is similar to that of the liquid crystal display of FIG. 4 and FIG. 5.

However, different from the thin film transistor array panel shown in FIG. 4 and FIG. 5, the color filters 230 are not provided on the thin film transistor array panel 100, but on the common electrode panel 200.

Also, the lower and upper passivation layers 180p and 180q are disposed in the thin film transistor array panel 100, the lower passivation layer 180p is made of the inorganic insulator such as silicon nitride or silicon oxide, and the upper passivation layer 180q is made of the organic insulator. It is preferable that the organic insulator of the upper passivation layer 180q has a dielectric constant of less than about 4.0, has photosensitivity, and provides a flat surface. The thickness of the upper passivation layer 180q may be substantially the same as the thickness of the color filter 230 of the liquid crystal display shown in FIG. 4 and FIG. 5.

Also, like the liquid crystal display shown in FIG. 4 and FIG. 6, an assistance member 125 may be disposed with the same layer as the gate line 121 under the protrusion 196 of the second subpixel electrode 191b which is connected to the first subpixel electrode 191a through the second contact hole 186, thereby complementing the contact of the first subpixel electrode 191a and the second subpixel electrode 191b.

Many characteristics of the liquid crystal display shown in FIG. 4 and FIG. 5 may be applied to the liquid crystal display shown in FIG. 7.

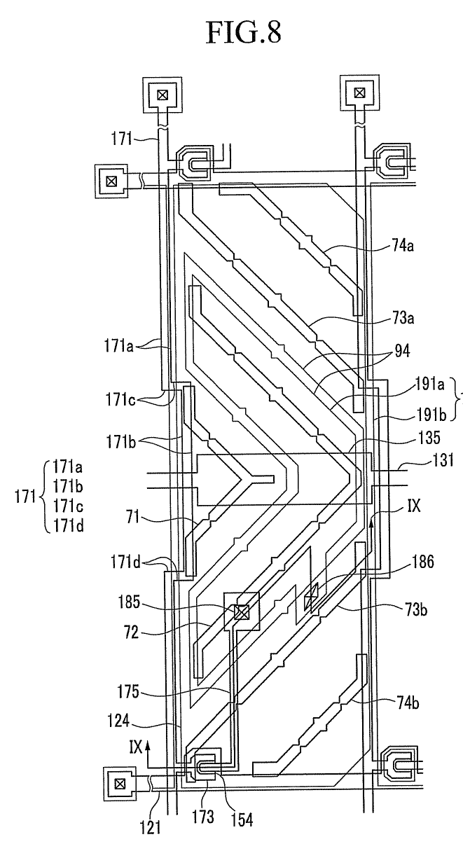

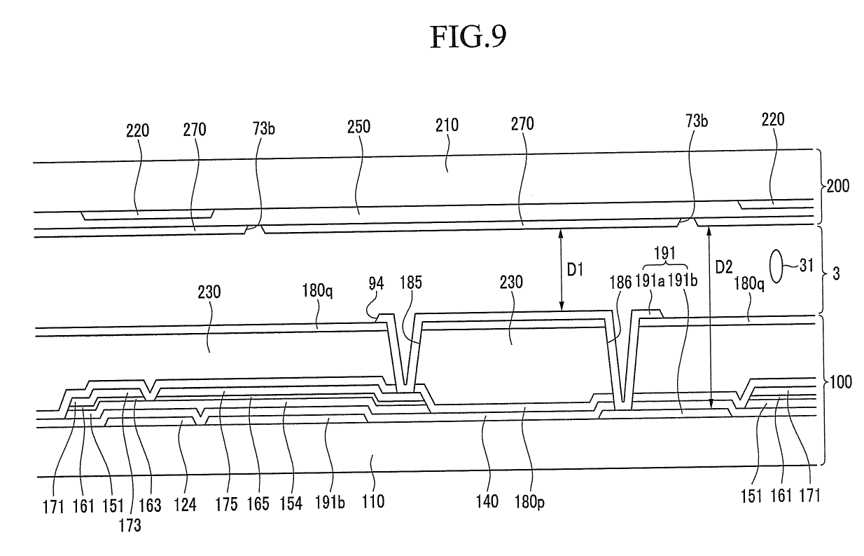

Next, an exemplary liquid crystal display according to another exemplary embodiment of the present invention will be described with reference to FIG. 8 and FIG. 9, and with further reference to FIG. 4. FIG. 8 is a layout view of one exemplary pixel in an exemplary liquid crystal display according to another exemplary embodiment of the present invention, and FIG. 9 is a cross-sectional view of the exemplary liquid crystal display shown in FIG. 8 taken along line IX-IX.

The layered structure of the liquid crystal display according to the present exemplary embodiment is almost the same as that of the liquid crystal display shown in FIG. 4 and FIG. 5.

Firstly, the thin film transistor array panel 100 will be described.

A plurality of second subpixel electrodes 191b and a plurality of gate lines 121 including gate electrodes 124 are formed or otherwise disposed on a substrate 110. A gate insulating layer 140, a plurality of semiconductor stripes 151, and a plurality of ohmic contact stripes and islands 161 and 165 are formed on the gate lines 121 and the substrate 110.

A plurality of data lines 171 including source electrodes 173, and a plurality of drain electrodes 175, are disposed on the ohmic contacts 161 and 165, and the lower passivation layer 180p is provided thereon. A plurality of color filters 230 are disposed on the lower passivation layer 180p, an upper passivation layer 180q is disposed on the color filters 230, and a plurality of first subpixel electrodes 191a are disposed on the upper passivation layer 180q.

In the plan view shown in FIG. 8, a pair of the first and second sub-pixel electrodes 191a and 191b forming one pixel electrode 191 engage with each other with a gap 94 disposed therebetween, and the first sub-pixel electrode 191a is interposed within the second sub-pixel electrode 191b. That is, the second subpixel electrode 191b encloses the first subpixel electrode 191a such that the first subpixel electrode 191a is nested within and spaced from the second subpixel electrode 191b in the plan view. Two corners of the second subpixel electrode 191b are chamfered, thereby forming the oblique edges. The oblique edges and the gap 94 form an angle of about 45 degrees or about 135 degrees with the gate line 121.

The color filter 230 of the liquid crystal display according to an exemplary embodiment of the present invention may have a thickness of about 1 μm to about 2 μm, and more preferably about 1.7 μm to about 1.9 μm.

In the plan view, the first and second subpixel electrodes 191a and 191b are separated from each other via the gap 94, and the gap 94 forms an angle of about 45 degrees or about 135 degrees with the gate line 121.

Each first subpixel electrode 191a is physically and electrically connected to the second subpixel electrode 191b through the second contact hole 186, which passes through the upper passivation layer 180q, the color filter 230, the lower passivation layer 180p, and the gate insulating layer 140.

The area occupied by the second subpixel electrode 191b may be larger than the area occupied by the first subpixel electrode 191a in the whole pixel electrode 191, and here, the area of the second subpixel electrode 191b may be larger than about 1.0 to about 2.0 times the area of the first subpixel electrode 191a.

Next, the common electrode panel 200 will be described.

A light blocking member 220 is formed or otherwise disposed on an insulating substrate 210, and an overcoat 250 is disposed thereon. In an alternative exemplary embodiment, the overcoat 250 may be omitted. A common electrode 270 is formed or otherwise disposed on the overcoat 250.

The common electrode 270 has a set of a plurality of cutouts 71, 72, 73a, 73b, 74a, and 74b.

One set of cutouts 71-74b faces one pixel electrode 191, and includes first and second central cutouts 71 and 72, upper cutouts 73a and 74a, and lower cutouts 73b and 74b.

The upper and lower cutouts 73a-74b respectively include an oblique branch, a transverse branch, and a longitudinal branch. The oblique branch substantially extends from the right edge of the pixel electrode 191 to the left, upper, or lower edge and parallel to the upper or lower cutouts of the pixel electrode 191. The transverse branch and the longitudinal branch extend from each end of the oblique branch while overlapping the edge of the pixel electrode 191, and form an obtuse angle with the oblique branch.

The first and second central cutouts 71 and 72 include a central transverse branch, a pair of oblique branches, and a pair of end longitudinal branches. The central transverse branch extends approximately from the right edge, a first side, of the pixel electrode 191 to the left edge or side, a second side opposite to the first side, according to the transverse central line of the pixel electrode 191, and a pair of oblique branches extend from the central transverse branch toward the left edge of the pixel electrode 191 and approximately parallel to the upper and lower cutouts 73a, 73b, 74a, and 74b. The end longitudinal branches extend from each end of the oblique branches while overlapping the left edge of the pixel electrode 191 and form an obtuse angle with the oblique branch.

The oblique portions of the cutouts 71-74b include notches with a triangular shape. In an alternative exemplary embodiment, the notches may have a quadrangular, a trapezoidal, or a semicircular shape.

The number and direction of the cutouts 71-74b may be changed according to design elements.

If the common electrode 270 is applied with the common voltage Vcom and the pixel electrode 191 is applied with the data voltage, an electric field substantially perpendicular to the surface of the display panels 100 and 200 is formed. Thus, liquid crystal molecules 31 of the liquid crystal layer 3 change directions so that the major axes thereof become perpendicular to the direction of the electric field in response to the electric field. The change degree of the polarization of the light that is incident to the liquid crystal layer 3 is changed according to the inclination degree of the liquid crystal molecules 31, and this change of the polarization appears as a change of the transmittance by the polarizer, thereby displaying images on the liquid crystal display.

On the other hand, the edges of the gap 94 between the field generating electrodes 191 and 270, the cutouts 71-74b of the common electrode 270, and the edges of the pixel electrodes 191 parallel to them distort the electric field to make the horizontal components perpendicular to determine the inclination direction of the liquid crystal molecules 31. The horizontal components of the electric field are perpendicular to the gap 94, the oblique edges of the cutouts 71-74b, and the oblique edges of the pixel electrode 191.

The gap 94 and the cutouts 71-74b divide the pixel electrode 191 into a plurality of subregions, and each of the subregions has two major edges forming the oblique angle with the main edges of the pixel electrode 191. Since the liquid crystal molecules 31 on each subregion tilt perpendicular to the major edges, the azimuthal distribution of the tilt directions are localized to four directions. In this way, the reference viewing angle of the liquid crystal display is increased by varying the tilt directions of the liquid crystal molecules 31.

At least one cutout 71-74b can be replaced with a protrusion or a depression, and the shape and disposition of the cutouts 71-74b can be modified.

As above-described, the liquid crystal display includes the first subpixel electrode 191a disposed on the lower passivation layer 180p, the color filters 230, and the upper passivation layer 180q, and the second subpixel electrode 191b disposed under the lower passivation layer 180p, the color filters 230, and the upper passivation layer 180q. Accordingly, since the first subpixel electrode 191a and the second subpixel electrode 191 are connected to each other via the second contact hole 186, the first subpixel electrode 191a and the second subpixel electrode 191b are applied with the same data voltage from the drain electrode 175 to which the first subpixel electrode 191a is connected via the first contact hole 185. However, the interval D1 between the first subpixel electrode 191a and the common electrode 270 and the interval D2 between the second subpixel electrode 191b and the common electrode 270 are different from each other, thus the intensity of the electric field within the region occupied by the first subpixel electrode 191a and within the region occupied by the second subpixel electrode 191b are different, thereby improving the side visibility.

In detail, the inclination angle of the liquid crystal molecule 31 is changed according to the intensity of the electric field such that the intensity of the electric field applied to the liquid crystal layer 3 between the field generating electrodes 191a and 270, and 191b and 270, and the inclined angle of the liquid crystal molecules 31, are different, and as a result the luminance of the two regions are different. Accordingly, if the intensity of the electric field applied to the liquid crystal layer 3 in the region occupied by the first subpixel electrode 191a and the intensity of the electric field applied to the liquid crystal layer 3 in the region occupied by the second subpixel electrode 191b are appropriately controlled, the side gamma curve may be approximate to the front gamma curve, thereby improving the side visibility.

In the liquid crystal display according to the present exemplary embodiment, although the first subpixel electrode 191a and the second subpixel electrode 191b are respectively on and under the passivation layers 180p and 180q, and the color filters 230, and are connected to each other through the contact hole 186 such that one thin film transistor is formed in one pixel and the same data signal is applied to the first and second subpixel electrodes 191a and 191b, it may be controlled that the electric field applied to the liquid crystal layer 3 within the region occupied by the first subpixel electrode 191a is stronger than the electric field applied to the liquid crystal layer 3 within the region occupied by the second subpixel electrode 191b. Accordingly, one thin film transistor is disposed in each pixel, thereby improving the aperture ratio of the liquid crystal display, and the same data signal is applied to the first and second subpixel electrodes 191a and 191b through one thin film transistor such that the side visibility may be increased through a simple driving method.

Also, as above-described, in the liquid crystal display according to an exemplary embodiment of the present invention, the liquid crystal layer 3 has an almost uniform thickness in the regions occupied by the first subpixel electrode 191a and the second subpixel electrode 191b. Accordingly, deterioration of the display quality that is generated due to the thickness of the liquid crystal layer 3 may be prevented.

The data lines 171 may not extend in a straight line on the whole, but may be bent at least twice. In detail, as shown in FIG. 8, the data lines 171 respectively include a first longitudinal portion 171a extending in the longitudinal direction, a first transverse portion 171c curved from the first longitudinal portion 171a in the rightward direction and extending in the transverse direction towards the respective pixel to which it is connected, a second longitudinal portion 171b curved downward from the first transverse portion 171c and extending in the longitudinal direction, and a second transverse portion 171d curved to the left side from the second longitudinal portion 171b and extending in the transverse horizontal direction away from the respective pixel to which it is connected. The first longitudinal portion 171a and the second longitudinal portion 171b of the data line 171 are disposed on imaginary straight lines that are respectively parallel to each other and separated from each other.

Both transverse boundaries of the first subpixel electrode 191a are respectively disposed neighboring the first longitudinal portion 171a of the data line 171 that is bent outward with respect to the pixel electrode 191 and the second longitudinal portion 171b of the neighboring data line 171, and are separated from each other by a predetermined interval. That is, when the first subpixel electrode 191a is projected on the same plane as the two neighboring data lines 171, the projection patterns thereof are separated from each other. Accordingly, the first subpixel electrode 191a does not overlap the data lines 171, and is separated from the data lines 171 such that the coupling effect between the first subpixel electrode 191a and the data lines 171 is reduced, thereby preventing cross talk that can be generated due to coupling between the first subpixel electrode 191a and the data lines 171.

Many characteristics of the liquid crystal panel assembly shown in FIG. 4 and FIG. 5 may be applied to the liquid crystal panel assembly shown in FIG. 8 and FIG. 9.

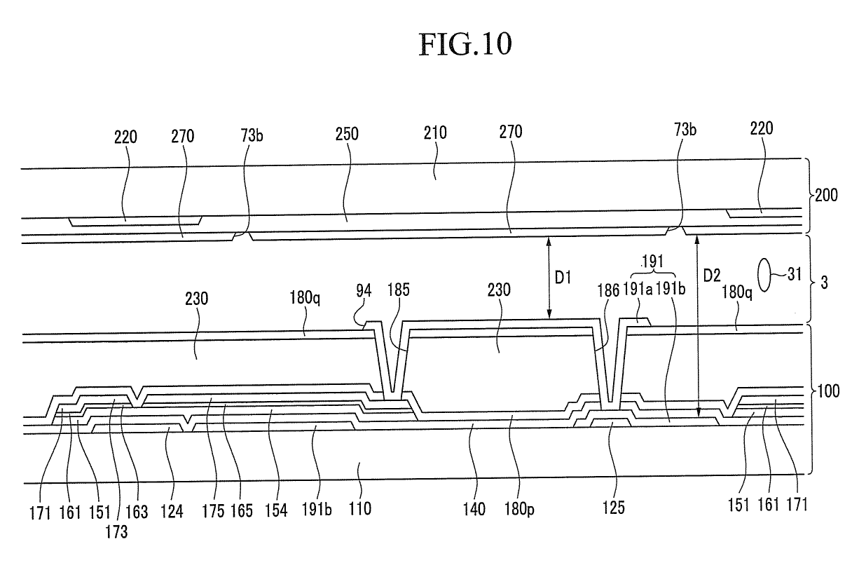

Next, an exemplary liquid crystal display according to another exemplary embodiment of the present invention will be described with reference to FIG. 10, and with further reference to FIG. 8. FIG. 10 is a cross-sectional view of an exemplary liquid crystal display according to another exemplary embodiment of the present invention.

The structure of the liquid crystal display according to the present exemplary embodiment is similar to the liquid crystal display of FIG. 8 and FIG. 9.

However, different from the thin film transistor array panel shown in FIG. 8 and FIG. 9, an assistance member 125 is disposed on the insulation substrate 110 in the same layer as the gate line 121 under the second contact hole 186 for connecting the second subpixel electrode 191b to the first subpixel electrode 191a. The assistance member 125 may reduce the depth of the second contact hole 186 which passes through the gate insulating layer 140, the lower passivation layer 180p, the color filter 230, and the upper passivation layer 180q such that contact of the first subpixel electrode 191a and the second subpixel electrode 191b is complemented.

Many characteristics of the liquid crystal display shown in FIG. 4 and FIG. 5 and the liquid crystal display shown in FIG. 8 and FIG. 9 may be applied to the liquid crystal panel assembly shown in FIG. 10.

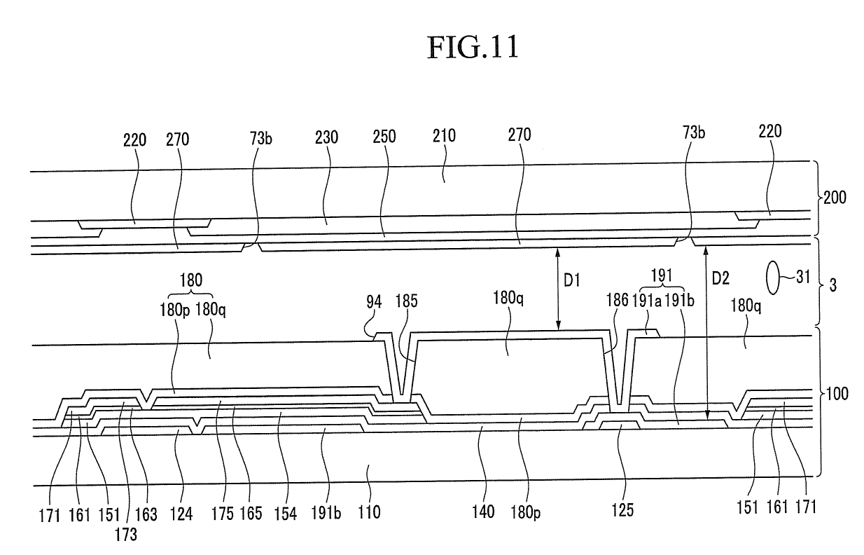

Next, an exemplary liquid crystal display according to another exemplary embodiment of the present invention will be described with reference to FIG. 11, and with further reference to FIG. 8. FIG. 11 is a cross-sectional view of an exemplary liquid crystal display according to another exemplary embodiment of the present invention.

The structure of the liquid crystal display according to the present exemplary embodiment is similar to the liquid crystal display of FIG. 8 and FIG. 9.

However, different from the thin film transistor array panel shown in FIG. 8 and FIG. 9, the color filters 230 are not formed on the thin film transistor array panel 100, but on the common electrode panel 200.

Also, the lower and upper passivation layers 180p and 180q are formed in the thin film transistor array panel 100, the lower passivation layer 180p is made of the inorganic insulator such as silicon nitride or silicon oxide, and the upper passivation layer 180q is made of the organic insulator. It is preferable that the organic insulator of the upper passivation layer 180q has a dielectric constant of less than about 4.0, has photosensitivity, and provides a flat surface. The thickness of the upper passivation layer 180q is almost the same as the thickness of the color filter 230 of the liquid crystal display shown in FIG. 4 and FIG. 5.

Also, unlike the liquid crystal display shown in FIG. 8 and FIG. 9, an assistance member 125 is disposed on the insulation substrate 110 within the same layer as the gate line 121 under the second contact hole 186, thereby complementing contact of the first subpixel electrode 191a and the second subpixel electrode 191b.

Many characteristics of the liquid crystal display shown in FIG. 4 and FIG. 5, and the liquid crystal display shown in FIG. 8 and FIG. 9, may be applied to the liquid crystal display shown in FIG. 11.

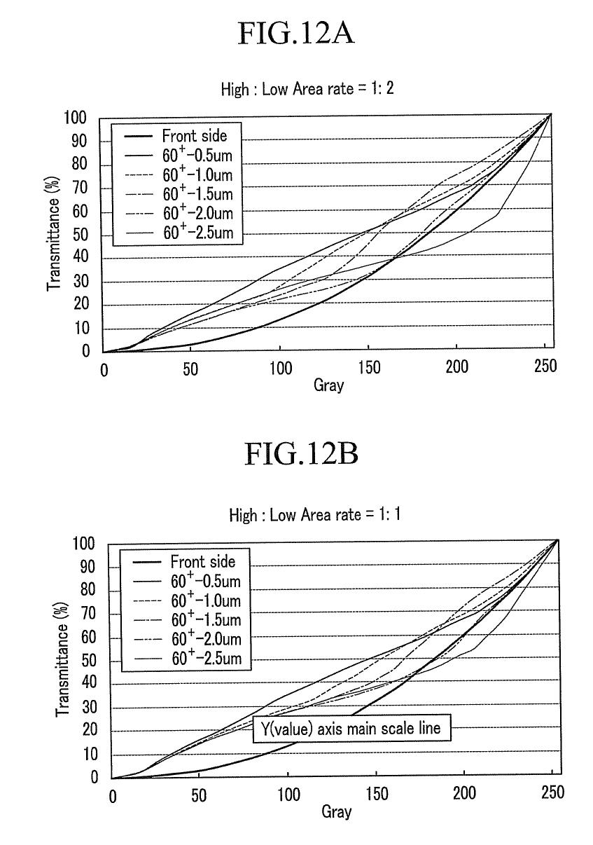

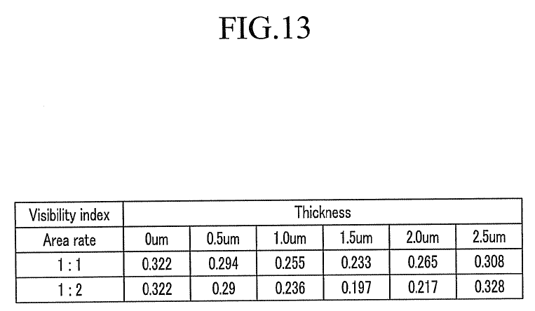

Next, an operation characteristic of an exemplary liquid crystal display according to an exemplary embodiment of the present invention will be described with reference to FIGS. 12A and 12B and FIG. 13, as one experimental example. FIGS. 12A and 12B are graphs of a gamma curved line showing transmittance per each gray according to the experimental example, and FIG. 13 is an index of visibility of the experimental example.

In the experimental example, the dielectric ratio of an organic layer disposed on the color filter 230 or the second subpixel electrode 191b is 3.5, the dielectric ratio of the liquid crystal layer 3 is 4.0, and the gap of the cell is about 3.9 μm. Under these conditions, there are two cases of the area ratio between the first subpixel electrode 191a and the second subpixel electrode 191b being about 1:1, as shown in FIG. 12B, and about 1:2, as shown in FIG. 12A, front transmittance and side transmittance of the liquid crystal display are observed and shown in FIGS. 12A and 12B while controlling the thickness of the color filter 230 or the organic layer disposed on the second subpixel electrode 191b in the range of 0 μm to 2.5 μm, and the visibility index per each gray is calculated and the averaged values thereof are shown in FIG. 13. The side transmittance is measured at an angle of about 60 degrees from the front, and the visibility index is calculated by the below formula.

1−u/u′

Here, u is the front transmittance and u′ is the side transmittance.

The luminance difference between the front and the side is reduced according to the decreasing of the visibility index, and when having about 0.2 the excellent visibility appears.

FIG. 12A shows the case that the area ratio between the first subpixel electrode 191a and the second subpixel electrode 191b is 1:2, and FIG. 12B shows the case that the area ratio between the first subpixel electrode 191a and the second subpixel electrode 191b is 1:1.

Referring to FIG. 12A and FIG. 12B, when the thickness of the color filter 230 or the organic layer disposed on the second subpixel electrode 191b is about 1.0 μm, 1.5 μm, and 2.0 μm, it is observed that the shape of the side gamma curve is similar to that of the front gamma curve. Also, compared with the case that the area ratio between the first subpixel electrode 191a and the second subpixel electrode 191b is 1:1, when the area ratio is 1:2, it is observed that the shape of the side gamma curve is similar to that of the gamma curve.

Referring to FIG. 13, when the thickness of the color filter 230 or the organic layer disposed on the second subpixel electrode 191b is about 1.0 μm, 1.5 μm, and 2.0 μm, it is observed that the visibility index is about 2, particularly, when the thickness of the color filter 230 or the organic layer is about 1.5 μm, it is observed that the visibility index is smallest. Like the result of FIG. 12A and FIG. 12B, compared with the area ratio between the first subpixel electrode 191a and the second subpixel electrode 191b of 1:1, in the case of 1:2, the visibility index is smaller.

According to this experimental example, like the exemplary embodiment of the present invention, when the area ratio between the first subpixel electrode 191a and the second subpixel electrode 191b is in the range of about 1:1 to about 1:2, and the thickness of the color filter 230 or the organic layer is in the range of about 1.0 μm to about 2.0 μm, it is observed that the excellent visibility characteristic appears.

According to the present invention, one thin film transistor is disposed in each pixel, thereby improving the aperture ratio of the liquid crystal display, and the same data signal is applied to the first and second subpixel electrodes 191a and 191b through one thin film transistor such that the side visibility may be increased through a simple driving method.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first insulating substrate;
a first subpixel electrode disposed on the first insulating substrate;
an organic insulator disposed on the first subpixel electrode and having a first contact hole; and
a second subpixel electrode disposed on the organic insulator and connected to the first subpixel electrode through the first contact hole.

2. The liquid crystal display of claim 1, wherein a thickness of the organic insulator is in a range of about 1 μm to about 2 μm.

3. The liquid crystal display of claim 2, wherein the thickness of the organic insulator is about 1.5 μm.

4. The liquid crystal display of claim 1, wherein the first subpixel electrode and the second subpixel electrode are disposed in one pixel, and an area ratio between the first subpixel electrode and the second subpixel electrode is in a range of about 1:1 to about 2:1.

5. The liquid crystal display of claim 1, wherein
the organic insulator is a color filter.

6. The liquid crystal display of claim 5, wherein
a surface of the organic insulator has substantially a same height as a surface of the second subpixel electrode.

7. The liquid crystal display of claim 5, wherein
the first subpixel electrode and the second subpixel electrode are disposed in one pixel, and an area ratio between the first subpixel electrode and the second subpixel electrode is in a range of about 1:1 to about 2:1.

8. The liquid crystal display of claim 1, further comprising:
a second insulating substrate facing the first insulating substrate;
a common electrode disposed on the second insulation substrate; and
a liquid crystal layer interposed between the first insulating substrate and the second insulating substrate.

9. The liquid crystal display of claim 8, wherein
a thickness of the liquid crystal layer between the first subpixel electrode and the common electrode is substantially same as a thickness of the liquid crystal layer between the second subpixel electrode and the common electrode.

10. The liquid crystal display of claim 8, further comprising:
a gate line and a data line disposed under the organic insulator; and
a thin film transistor connected to the gate line and the data line,
wherein the organic insulator has a second contact hole exposing a drain electrode of the thin film transistor, and
the second subpixel electrode is connected to the drain electrode through the second contact hole.

11. The liquid crystal display of claim 10, wherein,
if a data voltage is applied to the second subpixel electrode through the drain electrode, and
a common voltage is applied to the common electrode,
then an electric field generated between the first subpixel electrode and the common electrode is weaker than an electric field generated between the second subpixel electrode and the common electrode.

12. The liquid crystal display of claim 10, further comprising
an assistance member disposed under the first subpixel electrode in a region corresponding to the first contact hole, and disposed within a same layer as the gate line.

13. The liquid crystal display of claim 8, wherein
the liquid crystal layer includes a plurality of liquid crystal molecules, and
when a voltage is not applied between the first and second subpixel electrodes and the common electrode, long axes of the liquid crystal molecules are perpendicular to a surface of the first insulating substrate and a surface of the second insulating substrate.

14. The liquid crystal display of claim 13, wherein
the second subpixel electrode includes a plurality of minute branches having four subregions with different length directions of the minute branches.

15. The liquid crystal display of claim 14, wherein
the liquid crystal molecules are pretilted in the length directions of the minute branches.

16. The liquid crystal display of claim 15, wherein
the second subpixel electrode includes a transverse stem and a longitudinal stem forming a boundary of the four subregions.

17. The liquid crystal display of claim 13, wherein
the second subpixel electrode encloses the first subpixel electrode in a plan view.

18. The liquid crystal display of claim 17, further comprising a data line disposed between the organic insulator and the first insulating substrate, wherein
when the first subpixel electrode and the data line are projected on a same plane, their projection patterns are separated from each other.

19. The liquid crystal display of claim 18, wherein
the data line includes a first portion disposed on a first imaginary straight line, a second portion disposed on a second imaginary straight line separated from the first imaginary straight line and parallel to the first imaginary straight line, and a third portion connecting the first portion and the second portion to each other, and the second subpixel electrode overlaps the first portion of the data line.

20. The liquid crystal display of claim 18, wherein
the common electrode includes at least one cutout.
